(19) United States
(12) Patent Application Publication
(10) Pub. No.: US 2012/0001365 A1
(43) Pub. Date: Jan. 5, 2012

(54) CLAMPING DEVICE OF MICRO-NANO IMPRINT PROCESS AND THE METHOD THEREOF

(76) Inventor: Fuh-Yu Chang, Taipei City (TW)

(21) Appl. No.: 12/939,790

(22) Filed: Nov. 4, 2010

(30) Foreign Application Priority Data
Jun. 30, 2010 (TW) 099121380

(51) Int. Cl. B29C 59/02

(52) U.S. Cl. 264/293; 425/385

(57) ABSTRACT

The invention discloses a clamping device of the micro/nano imprint process and the method thereof for clamping a substrate. The clamping device comprises a first module, a second module and a locking module. The first module and the second module are used to accommodate and support at least one mold. The mold has a predetermined structure. The locking module is used to lock the first module and the second module. The clamping device drives the mold to imprint the substrate or the material layer of the substrate by a predetermined way.

### BACKGROUND OF THE INVENTION

1. Field of the Invention

The invention is related to a clamping device of the micro/nano imprint process and the method thereof. More particularly, the invention is related to the clamping device and the method of the micro/nano imprint process which can simplify the manufacturing process and increase utility of the machines.

2. Description of the Prior Art

The demand for the line width of the integrated circuits becomes narrower right now. In traditional photo lithography process, if the line width is narrower than the wavelength of the light source, it will cause to increase the difficulty of the manufacturing process due to the limitation of the light diffraction. Besides, the technology of mass production for the micro/nano structure has not been developed. So the micro/nano-imprint technology is developed and meets the demand for the narrower line width. There are also the advantages of fast machining, low cost and large-area machining for meeting the needs of mass production.

The principle of the micro/nano-imprint technology is to exert pressure to imprint the pre-designed micro-structure or the pre-designed structural characteristics to the forming material layer which is coated on a substrate by an imprinting machine. The forming material layer can generally be selected from such as Polymethylmethacrylate (PMMA) or other polymer materials. So the forming material layer can be formed and perform the following semiconductor manufacturing process for meeting the demand of the line width of the micro/nano structure.

Take Taiwan Patent No. 568,349 for example, the patent discloses the process of the nano-imprint comprising the steps of heating, imprinting, cooling and film-separating. The step of heating is to heat a forming material layer which is coated on a substrate to meet the operating temperature of the imprint. The step of imprinting is to drive the predetermined structure of the mold which is fixed on a first mold to move toward the substrate of a second mold by a driving source. When the mold contacts with the forming material layer, the mold begins to force and imprint the characteristics of the mold to the forming material layer. Then the pressure should be maintained so that the material layer can be formed and lowered to the appropriate temperature. The mold can separate from the forming material layer and begin to film-separating step for completing the process of the nano-imprint.

However, according to the micro/nano-imprint process of the prior art, the mold and the substrate placed on the machine will take long time for heating and cooling, it is difficult to increase the production capacity and reduce the cost.

Therefore, how to develop a simple process and increase the efficiency for the clamping device and the process of the micro/nano imprint will be an issue in this field.

### SUMMARY OF THE INVENTION

Accordingly, one aspect of the invention is to provide a clamping device of the micro/nano imprint process and the method thereof, for increasing the efficiency of the micro/nano imprint process.

In one embodiment, the clamping device of the invention is used to clamp a substrate. A material layer is formed on a surface of the substrate, or the substrate can be a deformable material. The clamping device comprises a first module, a second module and a locking module. The first module and the second module are used to accommodate and support at least one mold. The mold has a predetermined structure. The locking module is used to lock the first module and the second module, wherein the clamping device drives the mold to imprint the substrate or the material layer of the substrate by a predetermined way. The predetermined way is to force the first module or the second module with at least one pressure by a pressing device.

In addition, the clamping device of the invention comprises a material layer. The material layer can be polymer material, metal or glass, wherein the polymer material is a photo-resistance. Additionally, the clamping device of the invention further comprises an adjusting module for connecting the first module and the second module.

Furthermore, the clamping device of the invention comprises a fixing element located between the first module and the second module for maintaining a vertical distance between the first module and the second module or an inside pressure of the clamping device.

The clamping device further comprises a film-separating device for separating the substrate from the mold.

Compared to the prior art, the clamping device of the invention is removable from the pressing device. Additionally, the clamping device of the invention comprises a locking device for locking the first module and the second module. The invention allows the material layer of the substrate removing from the pressing device when the material layer has not been cooled. At the same time, the locking device can maintain the mold and the substrate in the pressing status for reducing the time of pressing the mold and the substrate into the pressing device and directly increasing the efficiency of the pressing device.

Accordingly, another aspect of the invention is to provide a method of the micro/nano imprint process for increasing the efficiency of the micro/nano imprint process.

In one embodiment, the method of the micro/nano imprint applies a clamping device for clamping a substrate. A material layer is formed on a surface of the substrate. The clamping device comprises a first module, a second module and a locking module. The first module and the second module are used to accommodate and support at least one mold. The mold has a predetermined structure. The locking module is used to lock the first module and the second module. The method of the micro/nano imprint comprises the following steps of: (S1) placing the mold and the substrate between the first module of the clamping device and the second module of the clamping device; (S2) driving the predetermined structure of the mold to imprint the substrate by a predetermined way; (S3) locking the first module and the second module for maintaining a relative position or pressure between the first module and the second module; and (S4) removing the substrate from the clamping device.

According to one embodiment, the step (S2) comprises following sub-steps of: (S22) heating the clamping device; and (S24) imprinting the structure by using the predetermined structure of the mold.

Furthermore, the method of the micro/nano imprint further comprises the following step between the step (S3) and the step (S4): (S31) lowering the temperature of the clamping device.

Compared to the prior art, the method of the micro/nano imprint of the invention allows the material layer of the substrate removing from the pressing device when the material layer has not been cooled. At the same time, the locking device can maintain the mold and the substrate in the pressing status for reducing the time of pressing the mold and the substrate into the pressing device and directly increasing the efficiency of the pressing device.

The objective of the present invention will no doubt become obvious to those of ordinary skill in the art after reading the following detailed description of the preferred embodiment, which is illustrated in following figures and drawings.

### BRIEF DESCRIPTION OF THE APPENDED DRAWINGS

FIG. 1 is a schematic diagram of a clamping device according to one embodiment of the invention.

FIG. 2 to FIG. 4 are schematic diagrams of using the clamping device according to one embodiment of the invention.

FIG. 5 is a flowchart of the method of micro/nano imprint process according to one embodiment of the invention.

### DETAILED DESCRIPTION OF THE INVENTION

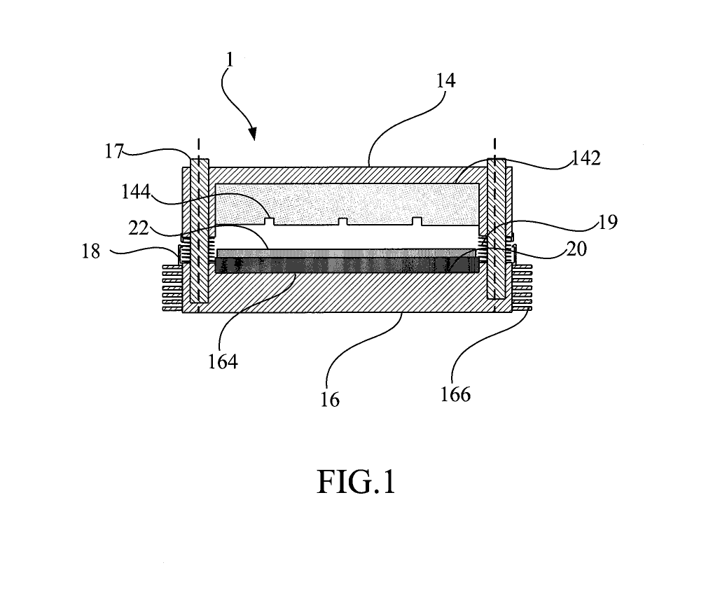

Please refer to FIG. 1. FIG. 1 is a schematic diagram of a clamping device 1 according to one embodiment of the invention. As shown in FIG. 1, the invention provides a clamping device 1 of the micro/nano imprint process, the clamping device 1 comprises a first module 14, a second module 16 and a locking module 18.

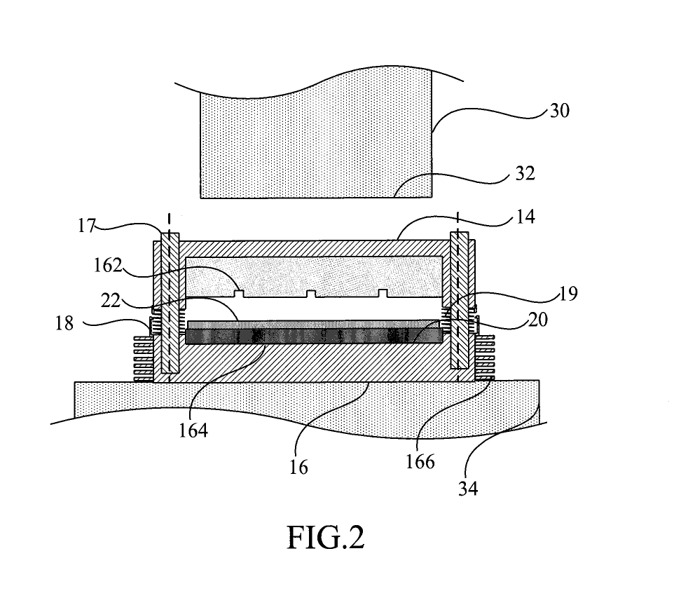

Please refer to FIG. 2 to FIG. 4. FIG. 2 to FIG. 4 are schematic diagrams of using the clamping device 1 according to one embodiment of the invention. As shown in FIG. 2, the clamping device 1 of the invention is placed in a pressing device 30. The pressing device 30 comprises an upper plate 32 and a lower plate 34.

Please refer to FIG. 1. In one embodiment, the clamping device 1 of the invention is used to clamp a substrate 20. The first module 14 is used to accommodate at least one mold 142. The mold 142 is placed on a surface of the first module 14 which is facing to the second module 16. The mold 142 comprises an upper surface and a lower surface. The upper surface and the lower surface are located relatively.

The upper surface of the mold 142 is connected to the first module 14. The lower surface of the mold 142 is related to the upper surface of the mold 142 and faces to the second module 16. The lower surface of the mold 142 has a predetermined structure 144 which is used to imprint the material layer 22 for forming a structure which is related to the predetermined structure 144 on the substrate 20 or a material layer 22 located on the surface of the substrate 20.

The line width of the predetermined structure 144 can be ranged from micron to nanometer level. In the embodiment, the first module 14 comprises a mold 142. Moreover, the number of the mold 142 can be increased accordingly corresponding to different situations.

The second module 16 comprises at least one locating structure 164 for supporting the substrate 20. In the embodiment, the locating structure 164 is a concave part. However, the locating structure 164 can be, but not limited to, a concave part. The locating structure 164 also can use vacuum suction force, lodging part, screw or other locating structure for fixing the substrate 20 on a surface of the second module 16 accurately in order to accurately control the relative horizontal and vertical location of the second module 16 for increasing the accuracy of the micro/nano imprint process. In addition, the number of the locating structure 164 can be adjusted according to the number of the substrate 20.

In the embodiment, a forming material layer 22 is formed on a surface of the substrate 20 where is facing to the first module 14. By using the predetermined structure 144 which is on the mold 142 to imprint the material layer 22 for forming a structure which is related to the predetermined structure 144. However, the invention can have, but not limited to, the forming material layer 22. According to the difference of the material of the substrate 20, the mold 142 can directly imprint on the surface of the substrate 20 to form a structure which is related to the predetermined structure 144.

In the embodiment, the substrate 20 is formed by semiconductor materials. However, the substrate 20 can be but not limited to semiconductor materials. The substrate 20 also can be made by metal, glass or polymer material according to the manufacturing process. In the embodiment, the substrate 20 has the forming material layer 22 on the surface of the predetermined structure 144. The forming material layer 22 can be polymer material, metal, glass or polymer material which is anti-corrosive, such as photo-resistance or PMMA, for protecting the substrate 20 from damaging in the following manufacturing process.

For the different type of the locating structure 164 which is on the second module 16, the second module 16 can comprise the locating structure 164 correspondently. If the substrate 20 can be located by vacuum suction force, the surface of the second module 16 shall have a plurality of holes which are interconnected with a vacuum source.

In the embodiment, in order to enhance the thermal conductivity of the first module 14 and the second module 16, the first module 14 and the second module 16 are made by metal. Furthermore, in order to enhance the thermal conductivity efficiency of the first module 14 and the second module 16, a plurality of fins 166 can be placed on the surface of the first module 14 or the second module 16 for enhancing the thermal conductivity efficiency of the clamping device 1. However, the first module 14 or the second module 16 does not need to have fins 166 necessarily.

The locking module 18 can be placed on the first module 14 or the second module 16 or on the first module 14 and the second module 16 at the same time. After the pressing device 30 presses the clamping device 1, the locking module 18 will lock and fix the first module 14 and the second module 16 on the relative position, and the locking module 18 can protect the first module 14 and the second module 16 from sliding or separating mutually. At the same time, the locking module 18 can maintain an inside pressure between the mold 142 and the substrate 20.

The locking module 18 comprises a fixing element (not shown). In the embodiment, the fixing element is a hook or other relative structure. However, for fixing the each part, the fixing element can also be a bolt with a spring or a concave part related to the bolt. However the locking module 18 can also be composed by a screw, piezoelectric driver, locating-server motor, magnetism suction device or other relative structure or element which can fix the first module 14 and the second module 16.

In the embodiment, the clamping device 1 further comprises an adjusting module 17. The adjusting module 17 is used to connect the first module 14 and the second module 16 for ensuring the vertical and the horizontal position of the second module 16 when the first module 14 moves and maintaining the accuracy of the micro/nano imprint process. In the embodiment, the adjusting module 17 is composed of a plurality of bars. The adjusting module 17 connects the first module 14 and the second module 16 for allowing the first module 14 to move vertically along the adjusting module 17. However, the adjusting module 17 does not need to be composed by a plurality of bars necessarily. The bolt or the inserting hole also can be placed on the first module 14 or the second module 16 for locating the position.

In the embodiment, the clamping device 1 further comprises a film-separating device 19. The film-separating device 19 is placed between the first module 14 and the second module 16 which is composed of springs along the adjusting module 17 for separating the first module 14 and the second module 16 from each other and taking out the substrate 20 which was imprinted. However the film-separating device 19 does not need to be springs, it also can be a screw, piezoelectric driver, locating-server motor, magnetism suction device which can recover the position.

Compared to the prior art, the clamping device 1 of the invention can be removed from the pressing device 30. The clamping device 1 further comprises the locking module 18. The locking module 18 is used to lock the first module 14 and the second module 16 for maintaining the pressure between the mold 142 and the substrate 20 after the pressing device 30 stops from forcing the clamping device 1 with a pressure. Furthermore, the locking module 18 allows the substrate 20 to be preheated before the substrate 20 enters into the pressing device 30, and allows the substrate 20 to remove from the pressing device 30 before the substrate 20 is cooled for directly reducing the time that the clamping device 1 occupies the time of the pressing device 30 and directly increasing the efficiency of the pressing device 30.

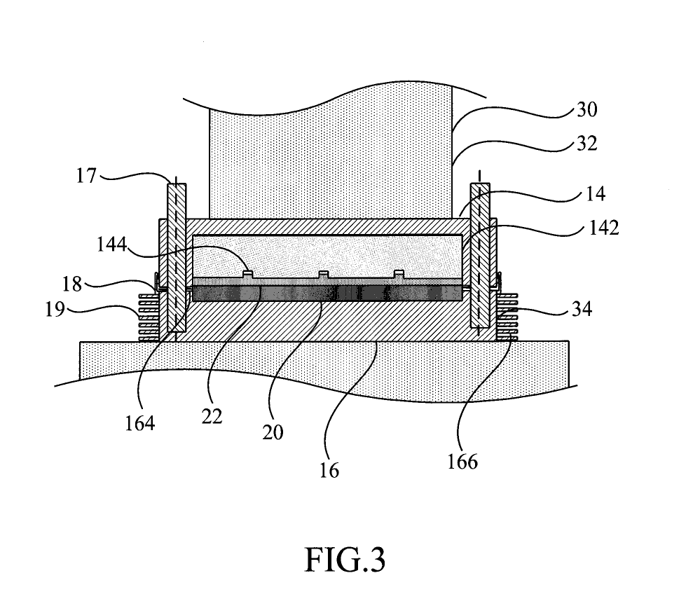

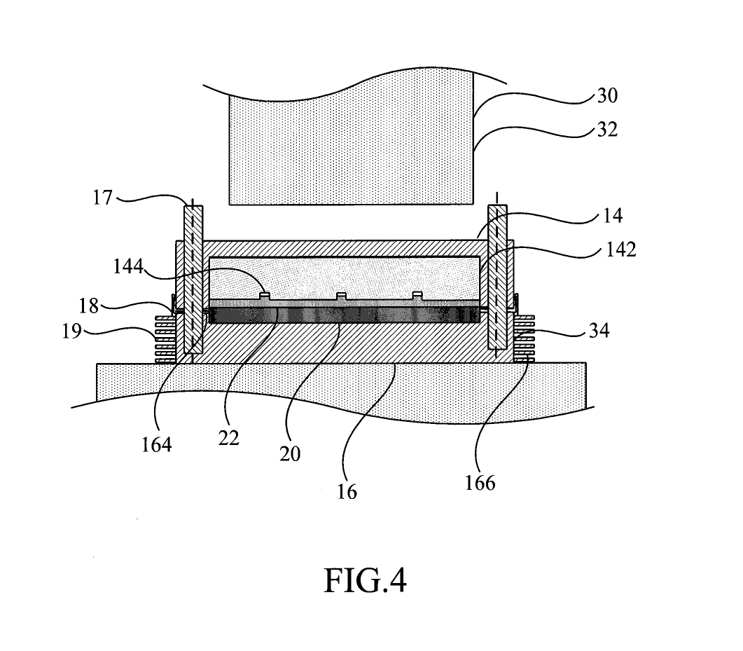

Please refer to FIG. 3. After the substrate 20 is adjusted and located, the upper plate 32 will move vertically toward the lower plate 34 for connecting and forcing the clamping device 1 with a pressure to the first module 14 move vertically along the move vertically. So the mold 142 which is placed on the first module 14 and the material layer 22 which is located on the substrate 20 will contact with each other. Then the predetermined structure 144 of the mold 142 can be imprinted to the material layer 22. Please refer to FIG. 4, when the predetermined structure 144 of the mold 142 is imprinted to the material layer 22, the locking module 18 will fix the relative position of the first module 14 and the second module 16. When the upper plate 32 backs to the vertical position, the first module 14 and the second module 16 can be maintained with the pressing status.

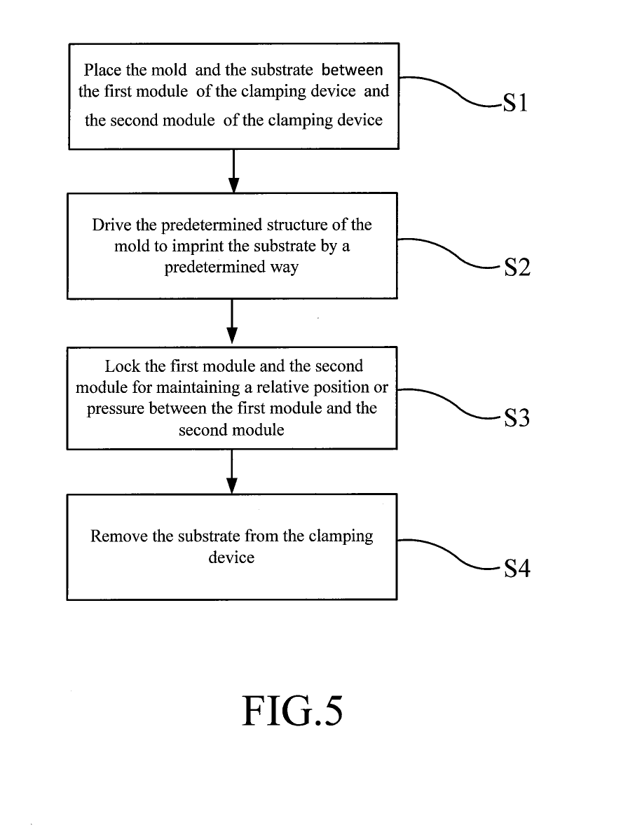

Please refer to FIG. 5. FIG. 5 is a flowchart of the method of micro/nano imprint process according to one embodiment of the invention. By using the clamping device 1 (as previously described), the invention provides a method of the micro/nano imprint process, which comprises the following steps of: (S1) placing the mold 142 and the substrate 20 between the first module 14 of the clamping device 1 and the second module 16 of the clamping device 1; (S2) driving the predetermined structure 144 of the mold 142 to imprint the substrate 20 by a predetermined way; (S3) locking the first module 14 and the second module 16 for maintaining a relative position or pressure between the first module 14 and the second module 16; and (S4) removing the substrate 20 from the clamping device 1.

The step (S1) is to place the mold 142 into the first module 14. An upper surface of the mold 142 is connected to the first module 14, and a lower surface of the mold 142 is related to the upper surface and face to the second module 16. The lower surface has the predetermined structure 144 on the mold 142 for imprinting the material layer 22, so that a structure which is related the predetermined structure 144 can be formed on the substrate 20 or the material layer 22 which is on the surface of the substrate 20. Additionally, the substrate 20 can be placed into the second module 16 of the clamping device 1. The second module 16 comprises a locating structure 164 for judging the position of the substrate 20 which is located on the second module 16. The locating structure 164 is a depression part, however the locating structure 164 does not need to have a depression part. It also can use vacuum suction force, lodging part, screw or other locating structure 164 to fix the substrate 20 on the surface of the second module 16 for accurately controlling the relative horizontal and vertical location to increase the accuracy of the micro/nano imprint process.

In the embodiment, the substrate 20 is formed by the semiconductor material. However it is unnecessary for the semiconductor material, according to the manufacturing process, the substrate 20 can be formed by metal, glass, or polymer material. In the embodiment, the material layer 22 is coated on the substrate 20. The forming material layer 22 is coated on the surface of the predetermined structure 144 which is related to the first module 14. The forming material layer 22 can be polymer material, metal or glass which can be used in the following semiconductor manufacturing process or corrosion resistant, such as PMMA, for protecting the substrate 20 from damaging in the follow-up semiconductor manufacturing process.

The line width of the predetermined structure 144 can be ranged from micron to nanometer level. In the embodiment, first module 14 comprises a mold 142, and the number of the mold 142 can be increased as the demand for the design.

The step (S2) is to drive the predetermined structure 144 of the mold 142 to imprint the substrate 20 by a predetermined way. The step (S2) comprises the following sub-steps of (S22) heating the clamping device 1 and (S24) imprinting the structure by using the predetermined structure 144 of the mold 142.

In the embodiment, the substrate 20 is placed on the second module 16 and fixed, then the clamping device 1 will be heated by the sub-step of (S22). Move the clamping device 1 and the substrate 20 to the heating module (not shown in FIG.), and heat the clamping device 1, the substrate 20 and the material layer 22 which is on the substrate 20, for heating the substrate 20 and the material layer 22 which is on the substrate 20 above the glass transition temperature (Tg) and softening the material so that the material layer 22 will be sticky and flexible for letting the predetermined structure 144 imprint or form when the substrate 20 or the material layer 22 is forced with a vertical pressure by the mold 142.

When the clamping device 1, substrate 20, and the material layer 22 which is on the substrate 20 are heated, the clamping device 1 is fixed and placed on the lower plate. The upper plate 32 drops to contact and force the upper surface of the first module 14 with a force, for letting the mold 142 which is connected with the first module 14 and the material layer 22 of the substrate 20 which is placed on the second module 16 contact with each other, so that the predetermined structure 144 which is on the mold 142 will be imprinted to the substrate 20 or the material layer 22.

In practice, according to the material or the manufacturing process of the substrate 20, sub-step (S24) can perform before than the sub-step (22), that is to said, imprinting before than heating. Furthermore, in an individual case, the sub-step (S22) can be omitted, meaning that directly using the predetermined structure 144 of the mold 142 to imprint the substrate 20 or the material layer 22 without preheating.

Furthermore, the sub-step (S24) is said that when the predetermined structure 144 of the mold 142 imprint to the substrate 20, the imprinting process can be a multilevel-pressing process, for using the pressing device 30 to force the first module 14 or the second module 16 with at least one-level pressure. If the number of the level is larger than one, the each level can be different.

In the embodiment, the heating module is a heating room which can heat many clamping device 1s at the same time.

Additionally, the locking module 18 will lock and fix the relative position of the first module 14 and the second module 16, for maintaining the pressing status before film-separating and protecting the first module 14 and the second module 16 from sliding or separating so that the material layer 22 of the substrate 20 which is not cooled and formed will not damage.

The step (S3) is to lock the first module 14 and the second module 16 for maintaining a relative position or pressure between the first module 14 and the second module 16. Furthermore, the method of the micro/nano imprint further comprises the following step between the step (S3) and the step (S4): (S31) lowering the temperature of the clamping device.

The step (S31) is to lower the temperature of the clamping device 1. When the material layer 22 of the substrate 20 cooled completely, the material layer 22 will recover strength before heated. If the first module 14 and the second module 16 are locked with each other by the locking module 18, the clamping device 1 can be cooled.

In the embodiment, when the locking module 18 locks completely, the upper plate 32 will separate from the upper surface of the clamping device 1 and then the clamping device 1 will be removed from the lower plate 34 and cooled naturally. However, the invention can be, but not limited to previous example, when the upper plate 32 locked completely, the upper plate 32 can maintain the relative position of the clamping device 1 and itself. After the clamping device 1 cooled completely on the lower plate, removing the clamping device 1 from the lower plate 34 can also be a way.

The step (S4) is to remove the substrate 20 from the clamping device 1. In the step of (S3), when the clamping device 1 is cooled, the locking module 18 and separating the mold 142 are open from the material layer 22, then the substrate 20 is taken out of the clamping device 1 for completing the all imprinting process.

Before the imprinting process, a high volatile and anti-sticking layer ban be coated between the mold 142 and the substrate 20 for assisting the material layer 22 in separating from the mold 142.

Compared to the prior art, the method of the micro/nano imprint of the invention allows the material layer 22 of the substrate 20 removing from the pressing device 30 when the material layer 22 has not been cooled. At the same time, the locking device can maintain the mold 142 and the substrate 20 in the pressing status for reducing the time of pressing the mold 142 and the substrate 20 into the pressing device 30 and directly increasing the efficiency of the pressing device 30.

With the example and explanations above, the features and spirits of the invention will be hopefully well described. Those skilled in the art will readily observe that numerous modifications and alterations of the device may be made while retaining the teaching of the invention. Accordingly, the above disclosure should be construed a claims.

What is claimed is:

1. A clamping device, applied in a micro/nano imprint process, for clamping at least one substrate, the clamping device comprising:
a first module;
a second module, the first module and the second module for accommodating and supporting at least one mold, the mold having a predetermined structure; and
a locking module for locking the first module and the second module;
wherein the clamping device drives the mold to imprint the substrate by a predetermined way.

2. The clamping device of claim 1, wherein a material layer is formed on a surface of the substrate, the clamping device drives the mold to imprint the material layer of the substrate by the predetermined way.

3. The clamping device of claim 2, wherein the substrate or the material layer can be a polymer material, a metal or a glass.

4. The clamping device of claim 3, wherein the polymer material is a photo-resistance.

5. The clamping device of claim 3, wherein the predetermined way is to force the first module or the second module with at least one pressure by a pressing device.

6. The clamping device of claim 3, further comprising an adjusting module for connecting the first module and the second module.

7. The clamping device of claim 1, wherein the locking module comprises a fixing element located between the first module and the second module, for maintaining a vertical distance between the first module and the second module or an inside pressure of the clamping device.

8. The clamping device of claim 3, further comprising a film-separating device for separating the substrate from the mold.

9. A method of a micro/nano imprint process, a clamping device applied for clamping a substrate, the clamping device comprising a first module, a second module and a locking module, the first module and the second module for accommodating and supporting a mold having a predetermined structure, the locking module for locking the first module and the second module, the method of the micro/nano imprint process comprising the following steps of:
(S1) placing the mold and the substrate between the first module of the clamping device and the second module of the clamping device;
(S2) driving the predetermined structure of the mold to imprint the substrate by a predetermined way;
(S3) locking the first module and the second module for maintaining a relative position or pressure between the first module and the second module; and
(S4) removing the substrate from the clamping device.

10. The method of the micro/nano imprint process of claim 9, wherein the step (S2) comprises following sub-steps of:
(S22) heating the clamping device; and
(S24) imprinting the structure by using the predetermined structure of the mold.

11. The method of the micro/nano imprint process of claim 9, further comprising the following step between the step (S3) and the step (S4):
(S31) lowering the temperature of the clamping device.

12. The method of the micro/nano imprint process of claim 9, wherein the clamping device further comprises an adjusting module, for connecting the first module and the second module.

13. The method of the micro/nano imprint process of claim 9, wherein the clamping device further comprises a fixing element located between the first module and the second module, for maintaining a vertical pressure between the first module and the second module or an inside pressure of the clamping device.

14. The method of the micro/nano imprint process of claim 9, wherein the predetermined way is to force the clamping device with at least one pressure by a pressing device.

15. The method of the micro/nano imprint process of claim 9, wherein the substrate or the material layer can be a polymer material, a metal or a glass.
